(19) United States
(12) Patent Application Publication
(10) Pub. No.: US 2024/0236729 A1
(43) Pub. Date: Jul. 11, 2024

(54) APPARATUS AND METHOD FOR MEASURING AND REPORTING PERFORMANCE MONITORING DATA IN WIRELESS COMMUNICATION SYSTEM

(71) Applicant: Electronics and Telecommunications Research Institute, Daejeon (KR)

(72) Inventors: Jeoung Lak HA, Daejeon (KR); Changki KIM, Daejeon (KR); Jaewook LEE, Daejeon (KR); Seung Han CHOI, Daejeon (KR)

(73) Assignee: Electronics and Telecommunications Research Institute, Daejeon (KR)

(21) Appl. No.: 18/370,533

(22) Filed: Sep. 20, 2023

(30) Foreign Application Priority Data
Jan. 6, 2023 (KR) 10-2023-0002416
Jan. 9, 2023 (KR) 10-2023-0003107
Jul. 24, 2023 (KR) 10-2023-0095898

(51) Int. Cl. H04W 24/08

(52) U.S. Cl. CPC H04W 24/08

(57) ABSTRACT

A wireless communication system is proposed. More particularly, an apparatus and a method for measuring and reporting performance monitoring data in a wireless communication system are proposed. Specifically, the operation method of a user plane function (UPF) in a wireless communication system includes receiving a QoS monitoring request from a session management function (SMF), wherein the QoS monitoring request may include monitoring of at least one of a data rate, a congestion level, a packet transmission count, a packet retransmission count, a packet retransmission ratio, a packet drop count, or a packet drop ratio.

### CROSS REFERENCE TO RELATED APPLICATION

The present application claims priority to Korean Patent Application Nos. 10-2023-0002416, 10-2023-0003107 and 10-2023-0095898, filed Jan. 6, 2023, Jan. 9, 2023, and Jul. 24, 2023, respectively, the entire contents of which are incorporated herein for all purposes by this reference.

### BACKGROUND OF THE INVENTION

### Field of the Invention

The present disclosure relates generally to a wireless communication system. More particularly, the present disclosure relates to an apparatus and a method for measuring and reporting performance monitoring data in a wireless communication system.

### Description of the Related Art

A 5G network is required to offer significantly higher speed and better performance than an existing 4G network. Accordingly, since the 5G network is required to process more traffic than the 4G network, it is important to monitor and manage a traffic performance to improve the service experience of a user in the 5G network.

There are several ways to monitor the traffic performance. The most common method is to measure the amount, speed, and delay time of traffic. By analyzing the data, it is possible to determine whether traffic quality is deteriorated. When traffic quality deteriorates, measures such as redirecting traffic to another network, increasing capacity of a server, or distributing traffic may be taken to improve the traffic quality. The monitoring of a traffic performance can play an important role in improving users' service experience in a 5G network.

### SUMMARY OF THE INVENTION

On the basis of the above discussion, the present disclosure provides an apparatus and a method for measuring and reporting performance monitoring data in a wireless communication system.

In addition, the present disclosure provides an apparatus and a method for measuring and reporting performance monitoring data for a packet data unit (PDU) session in a wireless communication system.

Furthermore, the present disclosure provides an apparatus and a method for measuring and reporting performance monitoring data for a quality of service (QoS) flow in a wireless communication system.

Additionally, the present disclosure provides an apparatus and a method for measuring and reporting at least one of a data rate, a congestion level, a packet transmission count, a packet retransmission count, a packet retransmission ratio, a packet drop count, or a packet drop ratio for a PDU session in a wireless communication system.

In addition, the present disclosure provides an apparatus and a method for measuring and reporting at least one of a data rate, a congestion level, a packet transmission count, a packet retransmission count, a packet retransmission ratio, a packet drop count, or a packet drop ratio for a QoS flow in a wireless communication system.

In order to achieve the above objectives, according to various embodiments of the present disclosure, there is provided an operation method of a user plane function (UPF) in a wireless communication system, the method includes: receiving a QoS monitoring request from a session management function (SMF), wherein the QoS monitoring request may include monitoring of at least one of a data rate, a congestion level, a packet transmission count, a packet retransmission count, a packet retransmission ratio, a packet drop count, or a packet drop ratio.

According to various embodiments of the present disclosure, there is provided an operation method of a radio access network (RAN) in a wireless communication system, the method including: receiving a QoS monitoring request from a session management function (SMF), wherein the QoS monitoring request may include monitoring of at least one of a data rate, a congestion level, a packet transmission count, a packet retransmission count, a packet retransmission ratio, a packet drop count, or a packet drop ratio.

According to various embodiments of the present disclosure, the operation method of a radio access network (RAN) in the wireless communication system includes: performing performance measurement, and reporting at least one of the data rate, the congestion level, the packet transmission count, the packet retransmission count, the packet retransmission ratio, the packet drop count, and the packet drop ratio which are results measured by the RAN to at least one of a session management function (SMF) or a user plane function (UPF).

According to various embodiments of the present disclosure, the operation method of a user plane function (UPF) in a wireless communication system includes: reporting at least one of a data rate, a congestion level, a packet transmission count, a packet retransmission count, a packet retransmission ratio, a packet drop count, or a packet drop ratio which are information measured by the UPF to a session management function (SMF).

According to various embodiments of the present disclosure, the user plane function (UPF) in the wireless communication system may include a transceiver, and a control part operatively connected to the transceiver, wherein the control part may receive the QoS monitoring request from the session management function (SMF), and may perform monitoring of at least one of a data rate, a congestion level, a packet transmission count, a packet retransmission count, a packet retransmission ratio, a packet drop count, or a packet drop ratio according to the QoS monitoring request.

According to various embodiments of the present disclosure, in the wireless communication system, the radio access network (RAN) may include the transceiver, and the control part operatively connected to the transceiver, wherein the control part may receive the QoS monitoring request from the session management function (SMF), and may perform the monitoring of at least one of a data rate, a congestion level, a packet transmission count, a packet retransmission count, a packet retransmission ratio, a packet drop count, or a packet drop ratio according to the QoS monitoring request.

According to various embodiments of the present disclosure, the user plane function (UPF) in the wireless communication system may include the transceiver, and the control part operatively connected to the transceiver, wherein the control part may report at least one of a data rate, a congestion level, a packet transmission count, a packet retransmission count, a packet retransmission ratio, a packet drop count, or a packet drop ratio which are measured by the UPF or are received from the RAN to the session management function (SMF) or a consumer NF.

According to various embodiments of the present disclosure, the radio access network (RAN) in the wireless communication system may include the transceiver, and the control part operatively connected to the transceiver, wherein the control part may report at least one of a data rate, a congestion level, a packet transmission count, a packet retransmission count, a packet retransmission ratio, a packet drop count, or a packet drop ratio which are measured by the RAN or received from UE to the session management function (SMF) or the user plane function (UPF).

According to apparatus and method according to various embodiments of the present disclosure, at least one of a data rate, a congestion level, a packet transmission count, a packet retransmission count, a packet retransmission ratio, a packet drop count, or a packet drop ratio for a packet data unit (PDU) session or a quality of service (QoS) flow is measured and reported, thereby enabling a user's service experience in a 5G network to be improved.

Effects obtainable from the present disclosure are not limited to the effects mentioned above, and other effects not mentioned will be clearly understood by those skilled in the art to which the present disclosure belongs from the description below.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 illustrates an example of a 5G network according to service based architecture (SBA) according to various embodiments of the present disclosure;

FIG. 2 illustrates an example of a processing procedure for a QoS monitoring request from a consumer NF according to an embodiment of the present disclosure;

FIG. 3 illustrates an example of Npcf_PolicyAuthorization_Subscribe request sent by the consumer NF to a PCF according to an embodiment of the present disclosure;

FIG. 4 illustrates an example of Npcf_SMPolicyControl_UpdateNotify request sent by the PCF to an SMF according to an embodiment of the present disclosure;

FIG. 5 illustrates an example of a session reporting rule (SRR) included in PFCP_SessionEstablishment request or PFCP_SessionModification request sent by the SMF to a UPF according to an embodiment of the present disclosure;

FIG. 6 illustrates another example of SRR included in PFCP_SessionEstablishment request or PFCP_SessionModification request sent by the SMF to the UPF according to an embodiment of the present disclosure;

FIG. 7 illustrates an example of NGAP_PDUSessionResourceModify request sent by the SMF to the RAN according to an embodiment of the present disclosure;

FIG. 8 illustrates an example of a method in which the UPF collects a performance measurement report from the RAN and the UPF directly reports to the consumer NF and a method in which the UPF report to the SMF reports;

FIG. 9 illustrates an example of a method in which the SMF collects a performance measurement report from the RAN and a performance measurement report from the UPF and reports to the PCF according to an embodiment of the present disclosure;

FIG. 10 illustrates an example of transmitting a performance measurement report from the RAN to the UPF by using PDU session user plane protocol (PSUPP), which is an extension header of a GTP-U header according to an embodiment of the present disclosure;

FIG. 11 illustrates an example of a case in which the UPF directly reports collected QoS measurement information to a consumer NF according to an embodiment of the present disclosure;

FIG. 12 illustrates another example of a case in which a UPF directly reports the collected QoS measurement information to a consumer NF according to an embodiment of the present disclosure;

FIG. 13 illustrates an example of reporting of the UPF to the SMF according to an embodiment of the present disclosure;

FIG. 14 illustrates another example of reporting of the UPF to the SMF according to an embodiment of the present disclosure;

FIG. 15 illustrates an example of reporting of the RAN to the SMF according to an embodiment of the present disclosure;

FIG. 16 illustrates an example of reporting of the SMF to the PCF according to an embodiment of the present disclosure;

FIG. 17 illustrates an example of reporting of the PCF to a consumer NF according to an embodiment of the present disclosure;

FIG. 18 illustrates an example of measuring a data rate and a congestion level, etc. according to an embodiment of the present disclosure;

FIG. 19 illustrates configuration of a network entity in a wireless communication system according to various embodiments of the present disclosure; and

FIG. 20 illustrates a configuration diagram of a RAN in a wireless communication system according to various embodiments of the present disclosure.

### DETAILED DESCRIPTION OF THE INVENTION

Terms used in the present disclosure are only used to describe a specific embodiment, and may not be intended to limit the scope of other embodiments. Singular expressions may include plural expressions unless the context clearly dictates otherwise. Terms used herein, including technical or scientific terms, may have the same meaning as commonly understood by those skilled in the art described in the present disclosure. Among terms used in the present disclosure, terms defined in general dictionaries may be interpreted as having the same or similar meaning to meaning in the context of the related technology, and are not to be construed in an idealized or excessively formal sense unless explicitly defined in the present disclosure. In some cases, even terms defined in the present disclosure cannot be interpreted to exclude embodiments of the present disclosure.

In various embodiments of the present disclosure described below, hardware-based approaches are described as examples. However, since various embodiments of the present disclosure include technology using both hardware and software, the various embodiments of the present disclosure do not exclude software-based approaches.

Hereinafter, the present disclosure relates to an apparatus and a method for measuring and reporting performance monitoring data in a wireless communication system. Specifically, the present disclosure describes a technique for improving a user's service experience in a 5G network in a wireless communication system.

In the following description, terms referring to signals, terms referring to channels, terms referring to control information, terms referring to network entities, and terms referring to components of a device, etc. are used for convenience of description. Accordingly, the present disclosure is not limited to the terms described below, and other terms having equivalent technical meanings may be used.

In addition, although the present disclosure describes various embodiments by using terms used in some communication standards (e.g., 3rd Generation partnership project (3GPP)), this is only examples for description. Various embodiments of the present disclosure may be easily modified and applied to other communication systems.

The present disclosure can provide an apparatus and a method for measuring and monitoring a traffic performance as a way to improve a user's service experience in a 5G network. Through the monitoring of a traffic performance, it is possible to immediately respond to decrease in traffic quality, thereby improving a user's service experience.

A 5G system may provide an apparatus and a method for monitoring uplink (UL) delay, downlink (DL) delay, and RoundTrip delay for ultra-reliable and low latency communications (URLLC). A policy control function (PCF) receiving a request for monitoring UL delay, DL delay, or RoundTrip delay for a quality of service (QoS) flow from a consumer NF (a network function) sends a request for monitoring UL delay, DL delay, or Round Trip delay for the corresponding QoS flow to a session management function (SMF). In this case, the policy control function (PCF) may send the request to the SMF by including whether or not to directly report to the consumer NF. The SMF instructs the request for monitoring UL delay, DL delay, or RoundTrip delay to a user plane function (UPF), and may include whether to directly report to the consumer NF. In addition, the SMF may transmit the request for monitoring UL delay, DL delay, or RoundTrip delay for the corresponding QoS flowto a radio access network (RAN) via an access and mobility management function (AMF). The UPF measures the UL delay or DL delay for a corresponding QoS flow according to instructions from the SMF, calculates a UL delay or DL delay measurement considering result for a corresponding QoS flowfrom the RAN, and may transmit the measurement result of the UL delay, DL delay, or RoundTrip delay to the SMF, to the consumer NF, or to both. The SMF may send UL delay, DL delay, or RoundTrip delay from the UPF to the PCF as needed, and the PCF may send the same to the consumer NF.

According to one embodiment, the consumer NF may mean an NF using a service for monitoring QoS including UL delay, DL delay, or RoundTrip delay.

A conventional method may include a function of measuring only UL delay, DL delay, or RoundTrip delay for a QoS flow and transmitting the same to a consumer NF. The present disclosure may further include the measuring and reporting of at least one of a data rate, a congestion level, a packet transmission count, a packet retransmission count, a packet retransmission ratio, a packet drop count, or a packet drop ratio for a PDU session or a QoS flow.

According to the present disclosure, this disclosure comprises commands for the monitoring of at least one of a data rate, a congestion level, a packet transmission count, a packet retransmission count, a packet retransmission ratio, a packet drop count, or a packet drop ratio may be added to relevant information elements and related messages for QoS monitoring request. When the monitoring of at least one of a data rate, a congestion level, a packet transmission count, a packet retransmission count, a packet retransmission ratio, a packet drop count, or a packet drop ratio are performed on the basis of events, thresholds thereof may be provided.

According to the present disclosure, at least one of a data rate, a congestion level, a packet transmission count, a packet retransmission count, a packet retransmission ratio, a packet drop count, or a packet drop ratio as measured performance data may be added to relevant information elements and related messages for QoS monitoring report.

According to one embodiment, the number of bits per second of a session, a data rate of an uplink QoS flow, or a downlink QoS flow may be expressed in bps, kbps, or Mbps, etc.

According to one embodiment, a congestion level indicates a degree to which uplink user traffic or downlink user traffic waits in a queue, may indicate the amount of time spent waiting in a buffer in seconds, milliseconds, microseconds, or nanoseconds, or may indicate a degree to which a buffer is full relative to the size of the buffer of a queue as a percentage.

According to one embodiment, a congestion level may indicate a degree to which the buffer of a queue is filled to a predetermined level or higher as a percentage.

According to one embodiment, a case in which a congestion level is a predetermined level or higher is regarded as a congestion situation, and the congestion level may indicate only whether or not congestion is present.

According to one embodiment, a packet transmission count, a packet retransmission count, and a packet drop count may be respectively represented as the number of transmitted packets, the number of retransmitted packets, and the number of discarded packets during a unit time.

According to one embodiment, a packet retransmission ratio and a packet drop ratio may be represented as percentages (%) of a packet retransmission count and a packet drop count, respectively, relative to the total number of packets during a unit time.

According to one embodiment, result reporting information elements and related messages for QoS monitoring may further include measured performance data such as the average, maximum, or minimum values of at least one of a data rate, a congestion level, a packet transmission count, a packet retransmission count, a packet retransmission ratio, a packet drop count, or a packet drop ratio measured for a predetermined period of time.

According to the present disclosure, a data rate, a congestion level, a packet transmission count, a packet retransmission count, a packet retransmission ratio, a packet drop count, or a packet drop ratio may be measured for a user session or a QoS flow.

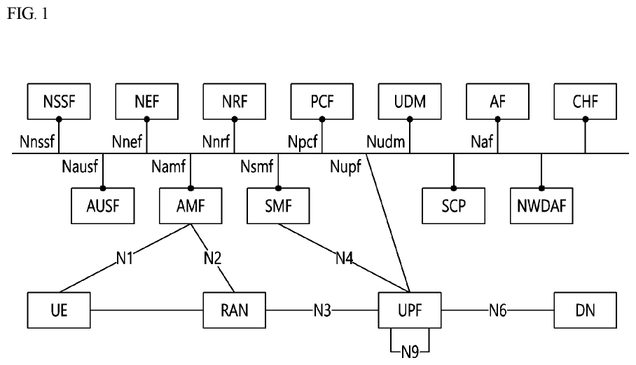

FIG. 1 illustrates an example of a 5G network structure according to service based architecture (SBA) according to various embodiments of the present disclosure.

Referring to FIG. 1, each network function (NF) of a network slice selection function (NSSF), a network exposure function (NEF), an NF repository function (NRF), a policy control function (PCF), a unified data management (UDM), an application function (AF), an authentication server function (AUSF), the access and mobility management function (AMF), and the session management function (SMF) in FIG. 1 may interface with each other by using a service based interface.

The user plane function (UPF) is a function that processes user data traffic, and may deliver user traffic data between the radio access network (RAN) and a data network (DN) and measure the performance of user traffic. The UPF may cooperate with the RAN to measure QoS including a delay, a data rate, and a congestion level, and the like.

The session management function (SMF) manages the user session and transfers control of the user session to the UPF so that the UPF can process user traffic. The SMF matches and manages sessions managed by the SMF itself and sessions managed by the UPF, and may control overall operations of the UPF. The policy control function (PCF) may manage service policies and may transmit policy information to functions such as other SMFs so that the service policies can be executed. The application function (AF) may manage policies for individual services and may transmit the application service policies to other functions such as the PCF so that the policies can be reflected in traffic processing. The network exposure function (NEF) provides an application programming interface (API) of a 5G network to the outside so that extended services using 5G network services can be made from outside AF. NEF may provide indirect interface between PCF and AF. A Charging Function (CHF) is in charge of charging and can perform charging on the basis of user data usage processed by the UPF. A network data analytics function (NWDAF) enables efficient operation of an entire network by collecting and analyzing data of each network element, including the UPF.

In the present disclosure, the consumer NF of performance measurement may include the AF, the NEF, or the NWDAF, but is not limited thereto. The consumer NF receives the performance measurement information from the UPF.

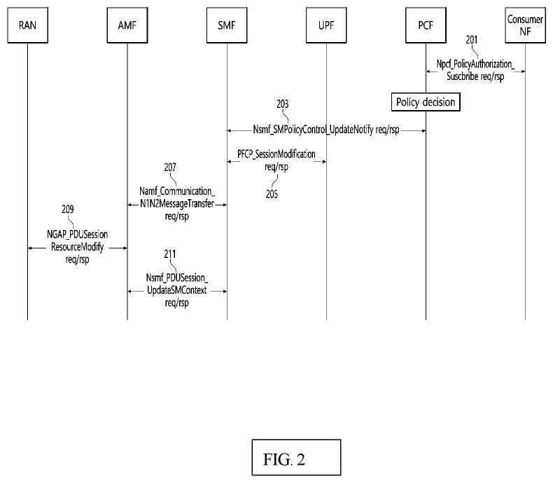

FIG. 2 illustrates an example of a processing procedure for a QoS monitoring request from a consumer NF according to an embodiment of the present disclosure.

Referring to FIG. 2, the consumer NF may transmit an Npcf_PolicyAuthorizationSuscribe req message including an item whose performance will be measured, a reporting frequency, a threshold, minimum wait time, and a monitoring period to the PCF so as to request performance measurement at 201. A Npcf_PolicyAuthorizationSuscribe rsp message may be transmitted from the PCF to the consumer NF in response to the Npcf_PolicyAuthorizationSuscribe req message. The consumer NF may also request for the performance measurement through NEF to PCF.

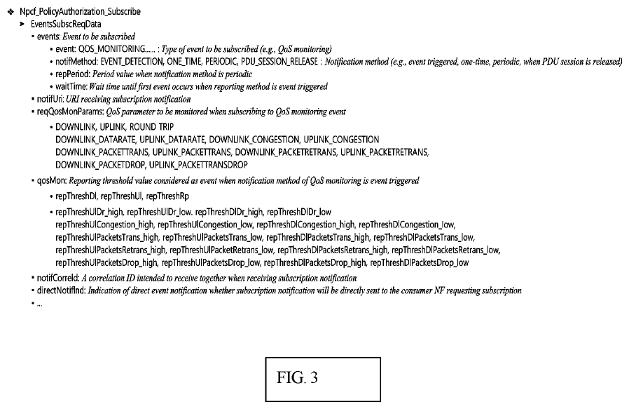

According to one embodiment, when the consumer NF intends to directly receive performance measurement information from the UPF, information necessary for direct reception from the UPF may be further included in the Npcf_PolicyAuthorizationSuscribe req message or the Npcf_PolicyAuthorizationSuscribe rsp message (see FIG. 3).

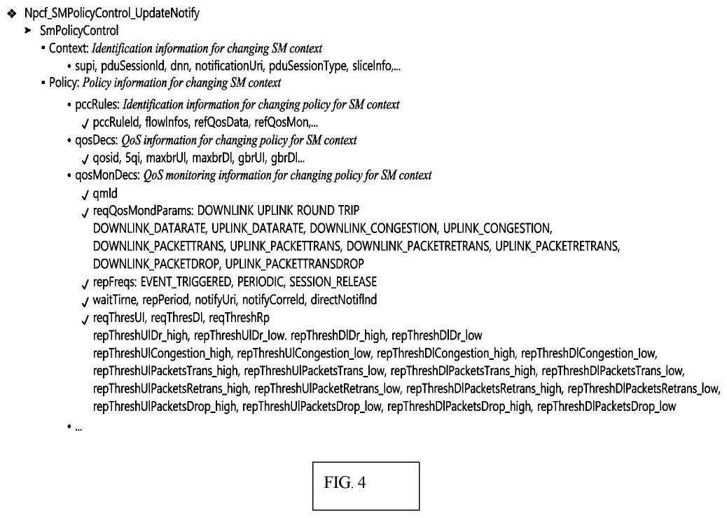

The PCF may transmit an Nsmf_SMPolicyControl_UpdateNotify req message including QoS monitoring request information to policy generated after performing authorization on QoS monitoring request from the consumer NF and may request performance measurement to the SMF. An Nsmf_SMPolicyControl_UpdateNotify rsp message may be transmitted from the SMF to the PCF in response to the Nsmf_SMPolicyControl_UpdateNotify req. According to one embodiment, the consumer NF's requesting information necessary for directly receiving the performance measurement information from the UPF may further included in Nsmf_SMPolicyControl_UpdateNotify req. (see FIG. 4).

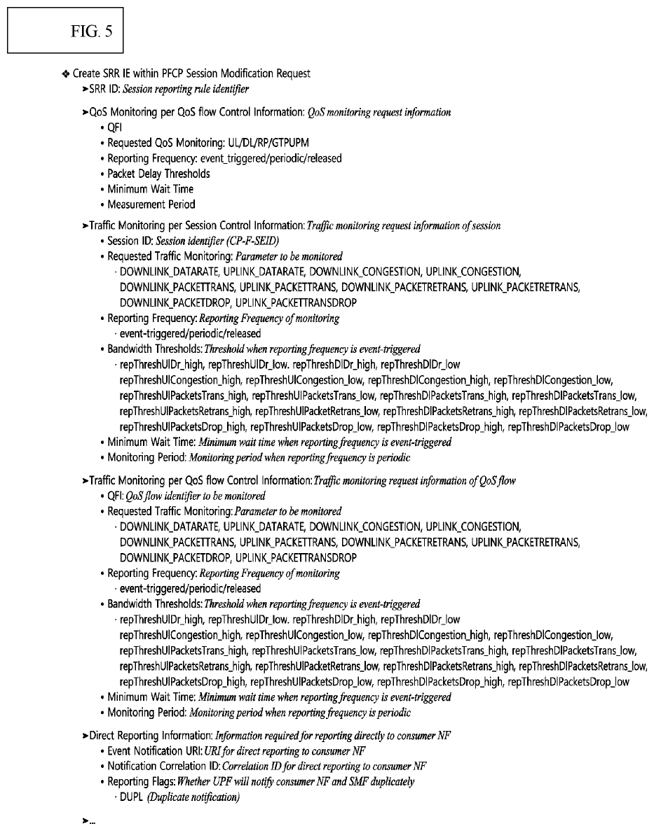

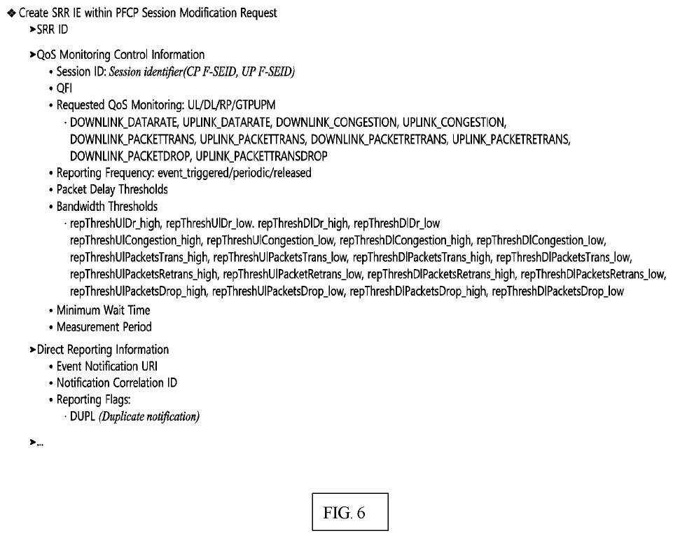

The SMF may transmit a PFCP_SessionModification req message including QoS monitoring request information to the UPF (205). Consumer NF's requesting information necessary for directly receiving the performance measurement information from the UPF may further included (see FIGS. 5 and 6). A PFCP_SessionModification rsp message may be transmitted from the UPF to the SMF in response to the PFCP_SessionModification req message.

The SMF may transmit an Namf_Communication_N1N2MessageTransfer req message including the PDUSessionResourceModify request transfer with QoS monitoring request information to be sent to the RAN to the AMF at 207. An Namf_Communication_N1N2MessageTransfer rsp message may be transmitted from the AMF to the SMF in response to the Namf_Communication_N1N2MessageTransfer req message. According to one embodiment, the Namf_Communication_N1N2MessageTransfer req or Namf_Communication_N1N2MessageTransfer rsp message may be used to transmit the QoS monitoring request information to the RAN via the AMF.

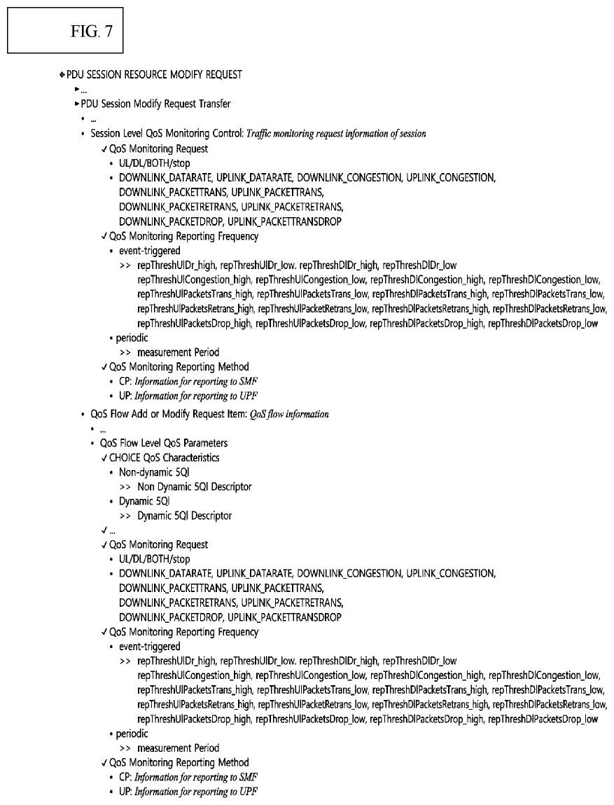

The AMF may transmit an NGAP_PDUSessionResourceModify req message including the QoS monitoring request information from the SMF to the RAN at 209 (see FIG. 7). An NGAP_PDUSessionResourceModify rsp message may be transmitted from the RAN to the AMF in response to the NGAP_PDUSessionResourceModify req.

The AMF may transmit a response to the PDUSessionResourceModify request transfer with QoS monitoring request information from the RAN to the SMF through an Nsmf_PDUSession_UpdateSMContext req message at 211. An Nsmf_PDUSession_UpdateSMContext rsp may be transmitted from the SMF to the AMF in response to Nsmf_PDUSession_UpdateSMContext req. According to one embodiment, the message of Nsmf_PDUSession_UpdateSMContext req or Nsmf_PDUSession_UpdateSMContext rsp may inform whether the QoS monitoring request information has been successfully delivered to the RAN.

The embodiment of FIG. 2 illustrates a case in which both the RAN and the UPF are involved in performance measurement. According to one embodiment, in the case of measurement in only one of the RAN and the UPF, an operation 205 to the UPF or only one of operations 207 to 211, which are operations to the RAN, may be used.

FIG. 3 illustrates an example of Npcf_PolicyAuthorization_Subscribe request sent by the consumer NF to the PCF according to an embodiment of the present disclosure.

Referring to FIG. 3, when an application session is preset between the consumer NF and the PCF, Npcf_PolicyAuthorization_Subscribe or Npcf_PolicyAuthorization_Update may be used, but before the application session is preset, Npcf_PolicyAuthorization_Create may be used. Npcf_PolicyAuthorization_Subscribe, Npcf_PolicyAuthorization_Update, and Npcf_PolicyAuthorization_Create may be sent by the consumer NF to the PCF indirectly through NEF. EventsSubscReqData included in Npcf_PolicyAuthorization_Subscribe, Npcf_PolicyAuthorization_Update, and Npcf_PolicyAuthorization_Create represents information to be subscribed to, and may include events to be subscribed to, Uri to receive subscribed events (notifUri), parameters for subscribed QoS monitoring events (reqQosMonParams), conditions of subscribed QoS monitoring events (qosMon), a correlation ID desired to be received together when receiving subscribed events, and whether to receive subscription results directly (directNotifind), etc.

According to one embodiment, parameters (reqQosMonParams) for subscribed QoS monitoring events may allow DOWNLINK_DATARATE, UPLINK_DATARATE, DOWNLINK_CONGESTION, UPLINK_CONGESTION, DOWNLINK_PACKETTRANS, UPLINK_PACKETTRANS, DOWNLINK_PACKETRETRANS, UPLINK_PACKETRETRANS, DOWNLINK_PACKETDROP, or UPLINK_PACKETDROP to be monitored, although parameters (reqQosMonParams) for subscribed QoS monitoring events were conventionally specified as DOWNLINK, UPLINK, and ROUND_TRIP to support only downlink delay, uplink delay, and roundtrip delay, respectively.

In addition, the maximum or minimum threshold of each of DOWNLINK_DATARATE, UPLINK_DATARATE, DOWNLINK_CONGESTION, UPLINK_CONGESTION, DOWNLINK_PACKETTRANS, UPLINK_PACKETTRANS, DOWNLINK_PACKETRETRANS, UPLINK_PACKETRETRANS, DOWNLINK_PACKETDROP, UPLINK_PACKETDROP as a condition of subscribed QoS monitoring events may include repThreshUIDr_high, repThreshUIDr_low, repThreshDIDr_high, repThreshDIDr_low, repThreshUICongestion_high, repThreshUICongestion_low, repThreshDICongestion_high, repThreshDICongestion_low, repThreshUIPacketsTrans_high, repThreshUIPacketsTrans_low, repThreshDIPacketsTrans_high, repThreshDIPacketsTrans_low, repThreshUIPacketsRetrans_high, repThreshUIPacketsRetrans_low, repThreshDIPacketsRetrans_high, repThreshDIPacketsRetrans_low, repThreshUIPacketsDrop_high, repThreshUIPacketsDrop_low, repThreshDIPacketsDrop_high, or repThreshDIPacketsDrop_low, or may include repThreshUIDr, repThreshDIDr, repThreshUICongestion, repThreshDICongestion, repThreshUIPacketsTrans, repThreshDIPacketsTrans, repThreshUIPacketsRetrans, repThreshDIPacketsRetrans, repThreshUIPacketsDrop, or repThreshDIPacketsDrop without specifying a maximum (high) or minimum (low).

Accordingly, when each of parameters described above exceeds a maximum threshold or is below a minimum threshold, an event may be triggered.

Terms for the parameters described above and terms used in the following specification may be understood as described in Table 1, but are not necessarily limited thereto.

TABLE 1

| Classification | Item | Description |
|---|---|---|
| UPLINK_{—} | repThreshUlDr_high, | Maximum, minimum, and average |
| DATARATE | repThreshUlDr_low, | values of uplink user traffic processing |
| | repThreshUlDr | speed measured per unit time (units |
| | | of bps, kbps, Mbps, Gbps, . . .) |
| DOWNLINK_{—} | repThreshDlDr_high, | Maximum, minimum, and average |
| DATARATE | repThreshDlDr_low, | values of downlink user traffic |
| | repThreshDlDr | processing speed measured per unit |
| | | time (units of bps, kbps, Mbps, |
| | | Gbps, . . .) |
| UPLINK_{—} | repThreshUlCongestion_high, | Maximum, minimum, and average |
| CONGESTION | repThreshUlCongestion_low, | values of buffering degree of uplink |
| | repThreshUlCongestion | user traffic measured per unit time |
| | | (units of buffer fullness (i.e., %, |
| | | percent) or delay seconds, |
| | | milliseconds, microseconds, |
| | | nanoseconds, . . .) |
| DOWNLINK_{—} | repThreshDlCongestion_high, | Maximum, minimum, and average |
| CONGESTION | repThreshDlCongestion_low, | values of buffering degree of downlink |
| | repThreshDlCongestion | user traffic measured per unit time |
| | | (Units of buffer fullness (i.e., %, |
| | | percent) or delay seconds, |
| | | milliseconds, microseconds, |
| | | nanoseconds, . . .) |
| UPLINK_{—} | repThreshUlPacketsTrans_high, | Maximum, minimum, and average |
| PACKETTRANS | repThreshUlPacketsTrans_low, | values of the number of packets |
| | repThreshUlPacketsTrans | processed per unit time of an uplink |
| | | QoS flow (units of thousands, |
| | | millions . . .) |
| DOWNLINK_{—} | repThreshDlPacketsTrans_high, | Maximum, minimum, and average |
| PACKETTRANS | repThreshDlPacketsTrans_low, | values of the number of packets |
| | repThreshDlPacketsTrans | processed per unit time of a downlink |
| | | QoS flow (units of thousands, |
| | | millions . . .) |
| UPLINK_{—} | repThreshUlPacketsRetrans_high, | Maximum, minimum, and average |
| PACKETRETRANS | repThreshUlPacketsRetrans_low, | values of the number or rate of |
| | repThreshUlPacketsRetrans | retransmitted packets per unit time of |
| | | an uplink QoS flow (units of tens, |
| | | hundreds . . . or %, precent) |
| DOWNLINK_{—} | repThreshDlPacketsRetrans_high, | Maximum, minimum, and average |
| PACKETRETRANS | repThreshDlPacketsRetrans_low, | values of the number or rate of |
| | repThreshDlPacketsRetrans | retransmitted packets per unit time of |
| | | a downlink QoS flow (units of tens, |
| | | hundreds . . . or %, precent) |
| UPLINK_{—} | repThreshUlPacketsDrop_high, | Maximum, minimum, and average |
| PACKETDROP | repThreshUlPacketsDrop_low, | values of the number or rate of |
| | repThreshUlPacketsDrop | discarded packets per unit time of an |
| | | uplink QoS flow (units of tens, |
| | | hundreds . . . or %, precent) |
| DOWNLINK_{—} | repThreshDlPacketsDrop_high, | Maximum, minimum, and average |
| PACKETDROP | repThreshDlPacketsDrop_low, | values of the number or rate of |
| | repThreshDlPacketsDrop | discarded packets per unit time of a |
| | | downlink QoS flow (units of tens, |
| | | hundreds . . . or %, precent) |

FIG. 4 illustrates an example of Npcf_SMPolicyControl_UpdateNotify request sent by the PCF to the SMF according to an embodiment of the present disclosure.

Referring to FIG. 4, SmPolicyControl containing policy information sent to the SMF by the PCF may include identification information on a changing SM context and policy information on a changing SM context.

Policy includes identification information about a policy to be changed and corresponding packet flows (flowinfos), and may include QoS setting information and QoS monitoring information to be applied to the packet flows.

DOWNLINK, UPLINK, and ROUND_TRIP were conventionally specified in the QoS monitoring information so as to support only downlink delay, uplink delay, and roundtrip delay, respectively, but according to the present disclosure, DOWNLINK_DATARATE, UPLINK_DATARATE, DOWNLINK_CONGESTION, UPLINK_CONGESTION, DOWNLINK_PACKETTRANS, UPLINK_PACKETTRANS, DOWNLINK_PACKETRETRANS, UPLINK_PACKETRETRANS, DOWNLINK_PACKETDROP, and UPLINK_PACKETDROP, etc. may be further monitored.

As repFreqs, the reporting frequency is expressed as “event triggered”, “periodic”, and “session released”, and in the case of event_triggered, the maximum or minimum threshold of at least one of DOWNLINK_DATARATE, UPLINK_DATARATE, DOWNLINK_CONGESTION, UPLINK_CONGESTION, DOWNLINK_PACKETTRANS, UPLINK_PACKETTRANS, DOWNLINK_PACKETRETRANS, UPLINK_PACKETRETRANS, DOWNLINK_PACKETDROP, or UPLINK_PACKETDROP may include repThreshUIDr_high, repThreshUIDr_low, repThreshDIDr_high, repThreshDIDr_low, repThreshUICongestion_high, repThreshUICongestion_low, repThreshDICongestion_high, repThreshDICongestion_low, repThreshUIPacketsTrans_high, repThreshUIPacketsTrans_low, repThreshDIPacketsTrans_high, repThreshDIPacketsTrans_low, repThreshUIPacketsRetrans_high, repThreshUIPacketsRetrans_low, repThreshDIPacketsRetrans_high, repThreshDIPacketsRetrans_low, repThreshUIPacketsDrop_high, repThreshUIPacketsDrop_low, repThreshDIPacketsDrop_high, or repThreshDIPacketsDrop_low, or may include repThreshUIDr, repThreshDIDr, repThreshUICongestion, repThreshDICongestion, repThreshUIPacketsTrans, repThreshDIPacketsTrans, repThreshUIPacketsRetrans, repThreshDIPacketsRetrans, repThreshUIPacketsDrop, or repThreshDIPacketsDrop without specifying a maximum (high) or minimum (low).

The meaning of each parameter is the same as described in FIG. 3, but is not necessarily limited thereto.

According to one embodiment, in the case of periodic monitoring, a monitoring period may be further provided in the parameters of FIG. 4. According to one embodiment, the monitoring period may represent a unit time for measurement.

FIG. 5 illustrates an example of a session reporting rule (SRR) included in PFCP_SessionEstablishment request and PFCP_SessionModification request sent by the SMF to the UPF according to an embodiment of the present disclosure

Referring to FIG. 5, the session reporting rule (SRR) included in PFCP_SessionEstablishment request and PFCP_SessionModification request may be SRR creation information or SRR update information included in the session setup request or session modification request of PFCP sent by the SMF to the UPF.

In FIG. 5, PFCP session modification is described, but PFCP session establishment may be applied in the same manner, and Create SRR IE is described, but Modify SRR IE may be applied in the same manner. The present disclosure may further include traffic monitoring request information of session or the traffic monitoring request information of the QoS flow in addition to conventional QoS monitoring request information. In this case, traffic monitoring information may include a session ID representing session to be monitored, a QoS flow identifier (QFI) representing a QoS flow to be monitored, parameters to be monitored with requested traffic monitoring indicating the parameters to be monitored, reporting frequency indicating the frequency of reporting, thresholds for each parameter, which are thresholds when the reporting frequency is event-triggered, minimum wait time which is minimum wait time for monitoring, and a monitoring period representing a monitoring time duration for monitoring, etc. The meaning of each parameter of FIG. may be the same as described in FIG. 3.

However, according to one embodiment, reporting flags for duplicate notification to the SMF and direct reporting, and URI and correlation ID required for direct reporting to the consumer NF may be further added.

FIG. 6 illustrates another example of SRR included in PFCP_SessionEstablishment request and PFCP_SessionModification request sent by the SMF to the UPF according to an embodiment of the present disclosure.

Referring to FIG. 6, FIG. 6 illustrates that the traffic monitoring request information is included within the conventional QoS monitoring request information, whereas the traffic monitoring request information is separately included in addition to the conventional QoS monitoring request information in FIG. 5. Each information element may be the same as each information element described in FIG. 5.

FIG. 7 illustrates an example of NGAP_PDUSessionResourceModify request sent by the SMF to the RAN according to an embodiment of the present disclosure.

Referring to FIG. 7, NGAP_PDUSessionResourceModify request may be PDU Session resource setup request transfer information or PDU Session resource modification request transfer information included in a session resource setup request or a session resource modification request of NGAP sent by the SMF to the RAN.

In FIG. 7, only PDU session resource modify request transfer of PDU session resource modify request is described, but PDU Session Resource Setup Request Transfer of PDU Session Resource Setup Request may be applied in the same manner.

The SMF conventionally specified DL, UL, and BOTH for a QoS monitoring request to the UPF so as to support only downlink delay, uplink delay, and roundtrip delay, respectively, but according to the present disclosure, may further monitor DOWNLINK_DATARATE, UPLINK_DATARATE, DOWNLINK_CONGESTION, UPLINK_CONGESTION, DOWNLINK_PACKETTRANS, UPLINK_PACKETTRANS, DOWNLINK_PACKETRETRANS, UPLINK_PACKETRETRANS, DOWNLINK_PACKETDROP, or UPLINK_PACKETDROP for a session and a QoS flow.

In addition, event triggered or periodic may be specified as QoS monitoring reporting frequency information.

In case of Event triggered PDU session resource modify request may include repThreshUIDr_high, repThreshUIDr_low, repThreshDIDr_high, repThreshDIDr_low, repThreshUICongestion_high, repThreshUICongestion_low, repThreshDICongestion_high, repThreshDICongestion_low, repThreshUIPacketsTrans_high, repThreshUIPacketsTrans_low, repThreshDIPacketsTrans_high, repThreshDIPacketsTrans_low, repThreshUIPacketsRetrans_high, repThreshUIPacketsRetrans_low, repThreshDIPacketsRetrans_high, repThreshDIPacketsRetrans_low, repThreshUIPacketsDrop_high, repThreshUIPacketsDrop_low, repThreshDIPacketsDrop_high, or repThreshDIPacketsDrop_low as a maximum or minimum threshold of each of DOWNLINK_DATARATE, UPLINK_DATARATE, DOWNLINK_CONGESTION, UPLINK_CONGESTION, DOWNLINK_PACKETTRANS, UPLINK_PACKETTRANS, DOWNLINK_PACKETRETRANS, UPLINK_PACKETRETRANS, DOWNLINK_PACKETDROP, or UPLINK_PACKETDROP, or may include repThreshUIDr, repThreshDIDr, repThreshUICongestion, repThreshDICongestion, repThreshUIPacketsTrans, repThreshDIPacketsTrans, repThreshUIPacketsRetrans, repThreshDIPacketsRetrans, repThreshUIPacketsDrop, or repThreshDIPacketsDrop without specifying a maximum (high) or minimum (low).

According to one embodiment, when each of the parameters described above exceeds a maximum threshold or is below a minimum threshold, an event may be triggered. In the case of Periodic, a monitoring period is specified and is periodically reported. In addition, the RAN may be provided method information for reporting to the SMF or UPF so that the RAN can perform the reporting to either the SMF or the UPF or both of the SMF and the UPF.

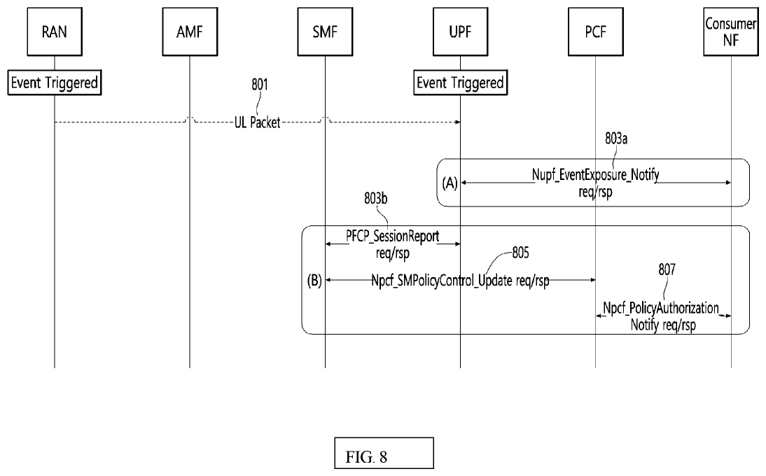

FIG. 8 illustrates an example of a method in which the UPF collects a performance measurement report from the RAN and the UPF directly reports to the consumer NF and a method in which the UPF report to the SMF.

Referring to FIG. 8, in the RAN, in the case of the arrival of a preset period or when change to a value equal to or greater than a threshold or a value equal to or less than the threshold, the measured performance may be reported to the UPF at 801.

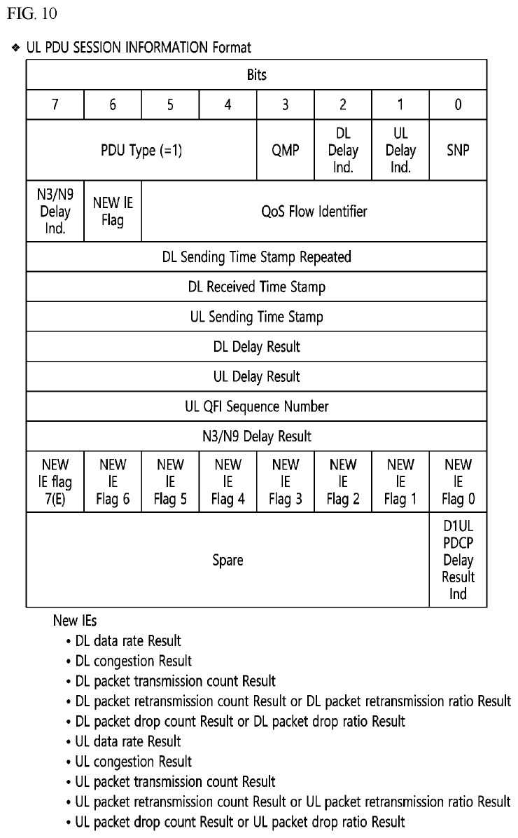

According to one embodiment, an operation 801 may be related to a case in which a QoS monitoring reporting method of FIG. 7 is UP (see FIG. 10).

According to one embodiment, in the case of measuring performance only in the UPF, the operation 801 may be omitted.

According to one embodiment, even in the UPF, in the case of the arrival of a preset period or when change to a value equal to or greater than a threshold or a value equal to or less than the threshold, a measured QoS value may be stored and may be combined with a value transmitted from the RAN. (In the case of measurement in both the RAN and the UPF, arithmetic average, maximum, or minimum values may be taken, or may be combined in an enumerated type according to a measurement interval) According to one embodiment, in the case of arrival of the monitoring period, the UPF and the RAN measure QoS including at least one of a data rate, a congestion level, a packet transmission count, a packet retransmission count, a packet retransmission ratio, a packet drop count, or a packet drop ratio, etc., wherein the monitoring period may be applied in a moving average method in which corresponding time is moved. The monitoring period may be preset in the RAN or UPF, and may be included and indicated in one or more of the messages of FIGS. 3, 4, 5, 6, and 7.

According to one embodiment, in the case of measurement in the RAN, the UPF may only use a measurement value transmitted as a UL packet from the RAN without using the UPF's measured value. The RAN may provide the measurement value to the UPF as illustrated in FIG. 10. The RAN may load user traffic to the UPF with a measured value, or when there is no user traffic to the UPF, a packet for sending a measured value may be generated to provide the measured value. The RAN may continuously report whether there is congestion to the UPF with every packet until the congestion occurring in the RAN is resolved.

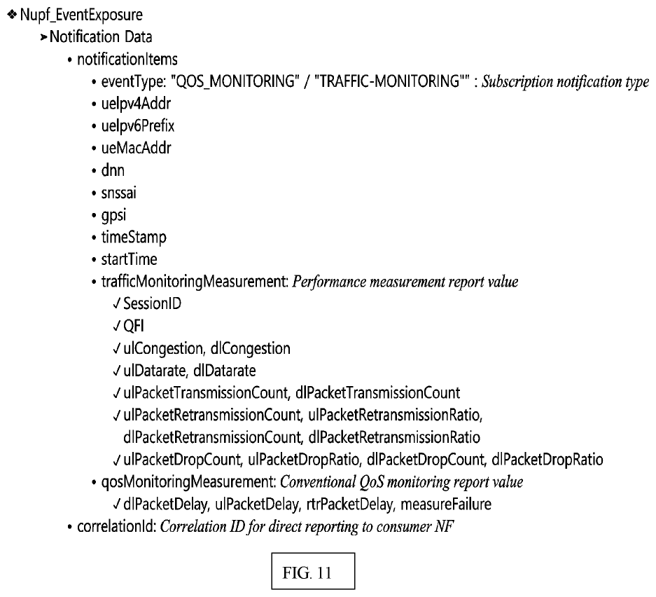

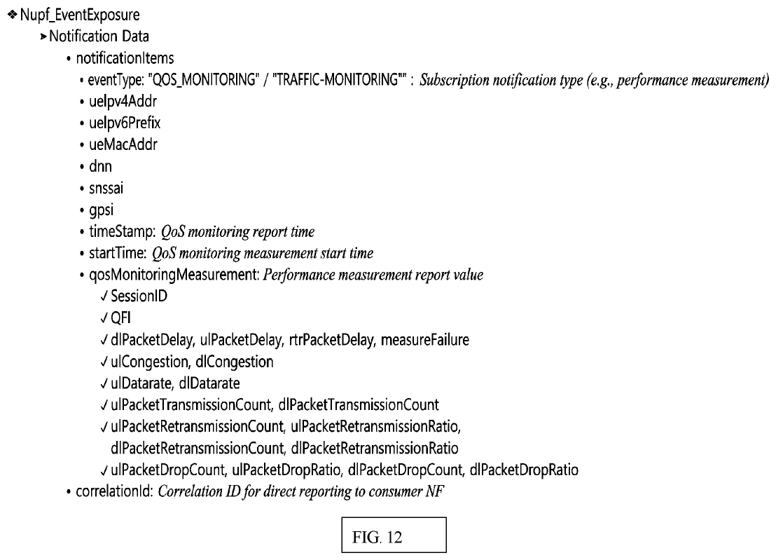

In an operation 803a, (A) the UPF may transmit a QoS monitoring report to a consumer NF through an Nupf_EventExposure_Notify req message according to direct reporting information received by the UPF in FIGS. 5 and 6 (see FIGS. 11 and 12). The Nupf_EventExposure_Notify rsp message may be transmitted from the consumer NF to the UPF in response to the Nupf_EventExposure_Notify req message.

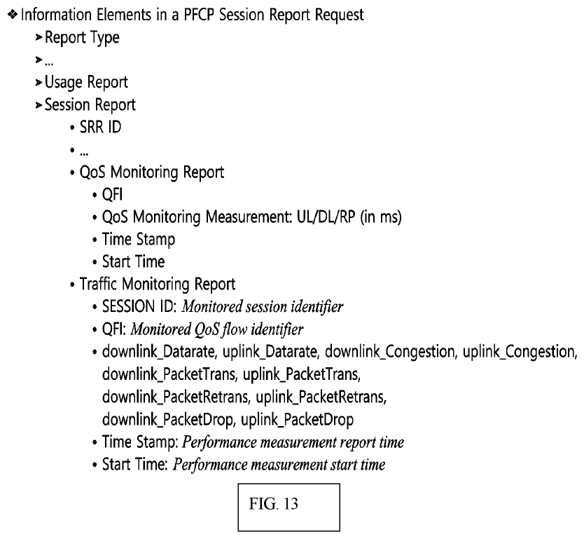

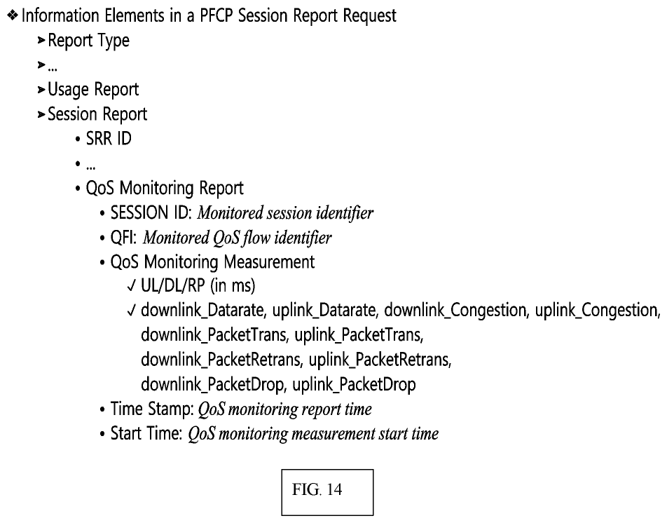

In an operation 803b, (B) when the UPF does not receive the direct reporting information in FIGS. 5 and 6, the UPF may transmit the QoS monitoring report to the SMF via PFCP_SessionReport req (see FIGS. 13 and 14). A PFCP_SessionReport rsp message may be transmitted from the SMF to the UPF in response to a PFCP_SessionReport req message.

In the operation 803a and the operation 803b, when DUPL of the direct reporting information received by the UPF in FIGS. 5 and 6 is set, the UPF may perform the transmission of the QoS monitoring report through the Nupf_EventExposure_Notify req message to the consumer NF and the transmission of the QoS monitoring report through the PFCP_SessionReport req message to the SMF according to the direct reporting information. The Nupf_EventExposure_Notify rsp message may be transmitted from the consumer NF to the UPF in response to Nupf_EventExposure_Notify req. The PFCP_SessionReport rsp message may be transmitted from the SMF to the UPF in response to PFCP_SessionReport req.

The SMF may report performance measurement information to the PCF by using an Npcf_SMPolicyControl_Update req message at 805. An Npcf_SMPolicyControl_Update rsp message may be transmitted from the PCF to the SMF in response to the Npcf_SMPolicyControl_Update req.

The PCF may report performance measurement information to the consumer NF by using an Npcf_PolicyAuthorization_Notify req message at 807. An Npcf_PolicyAuthorization_Notify rsp message may be transmitted from the consumer NF to the PCF in response to the Npcf_PolicyAuthorization_Notify req message. The PCF may report performance measurement information to consumer NF through NEF. According to one embodiment, performance measurement information may further include the average, maximum, or minimum values of at least one of a data rate, a congestion level, a packet transmission count, a packet retransmission count, a packet retransmission ratio, a packet drop count, or a packet drop ratio, which are measured for a predetermined period of time, for a specific PDU session or QoS flow.

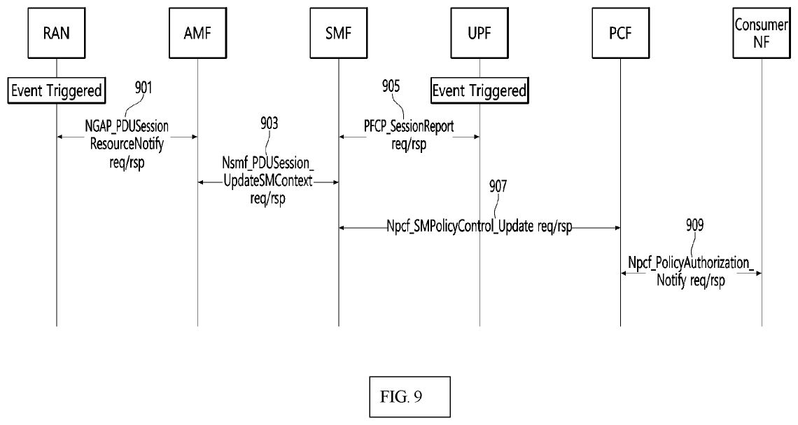

FIG. 9 illustrates an example of a method in which the SMF collects a performance measurement report from the RAN and a performance measurement report from the UPF and reports to the PCF according to an embodiment of the present disclosure.

Referring to FIG. 9, in the case of the arrival of a preset period in the RAN or when change to a value equal to or greater than a threshold or a value equal to or less than the threshold, an NGAP_PDUSessionResourceNotify req message may be transmitted to the AMF to report a measured performance to the SMF at 901. An NGAP_PDUSessionResourceNotify rsp message may be transmitted from the AMF in response to the NGAP_PDUSessionResourceNotify req message and may be received by the RAN at 901.

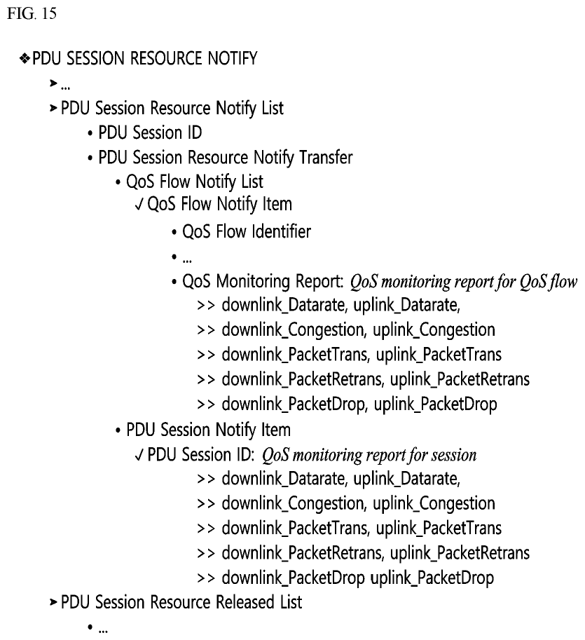

According to one embodiment, FIG. 9 may be related to a case in which the QoS monitoring reporting method of FIG. 7 is CP (see FIG. 15).

According to one embodiment, in the case of measuring performance only on the UPF, operations 901 and 903 may be omitted.

The AMF may transmit Nsmf_PDUSession_UpdateSMContext req including PDU Session Resource Notify Transfer information including performance measurement information received from the RAN to the SMF at 903. An Nsmf_PDUSession_UpdateSMContext rsp message may be transferred from the SMF to the AMF in response to the Nsmf_PDUSession_UpdateSMContext req message at 903.

In an operation 905, in the case of the arrival of a preset period or when change to a value equal to or greater than a threshold or a value equal to or less than the threshold, the PFCP_SessionReport req message including a measured QoS value may be reported to the SMF at 907 (see FIGS. 13 and 14). The PFCP_SessionReport rsp message may be transmitted from the SMF to the UPF in response to the PFCP_SessionReport req message at 903.

According to one embodiment, performance may be measured only in the RAN, and when the QoS monitoring reporting method is CP, the operation 905 may be omitted.

According to one embodiment, the SMF may select one of a value transmitted from the RAN and a value transmitted from the UPF or may combine the value transmitted from the RAN and the value transmitted from the UPF.

According to one embodiment, in the case of measurement in both the RAN and the UPF, measured performance information may have arithmetic average, maximum, or minimum values, or may be combined in an enumeration type.

According to one embodiment, in the case of measurement in the RAN, the UPF may only use a measurement value transmitted from the RAN without using the UPF's measured value.

According to one embodiment, in a case in which congestion is measured in the RAN and a congestion level is calculated in the UPF, the UPF may calculate a congestion level based on whether or not congestion is recorded in multiple packets transmitted from the RAN during unit time. A ratio of number of packets marked as congestion to number of all packets received by the UPF during unit time may be expressed as a percentage to be used as a congestion level.

According to one embodiment, in the case of measurement in the RAN, the RAN may use a performance measurement report value from UE for measuring a QoS value.

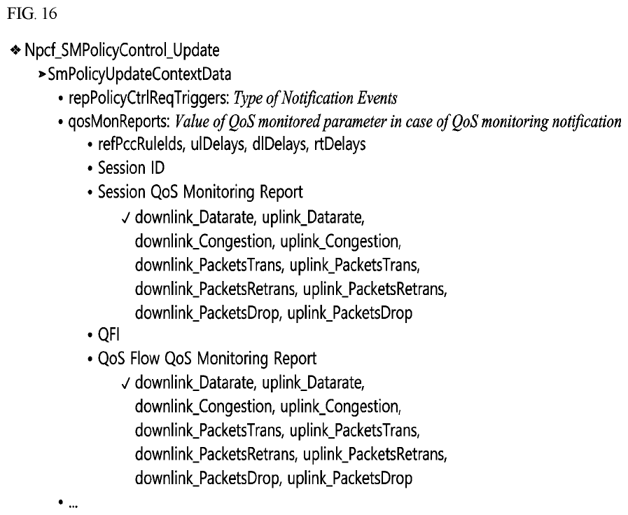

At the operation 907, the SMF may report performance information measured through the Npcf_SMPolicyControl_Update req message including performance measurement information to the PCF (see FIG. 16). The Npcf_SMPolicyControl_Update rsp message is responded to the SMF from the PCF in response to the Npcf_SMPolicyControl_Update req message.

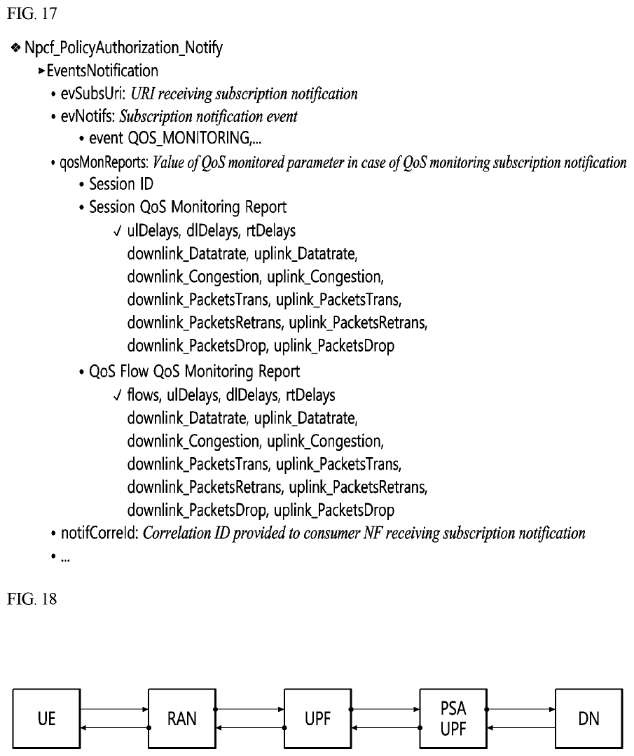

At an operation 909, the PCF may report through an Npcf_PolicyAuthorizationNotify req message including performance measurement information to the consumer NF (see FIG. 17). The Npcf_PolicyAuthorizationNotify req message may be responded to the PCF from the consumer NF in response to an Npcf_PolicyAuthorizationNotify rsp message. The PCF may report performance measurement information to consumer NF through NEF.

FIG. 10 illustrates an example of transmitting a performance measurement report from the RAN to the UPF by using PDU session user plane protocol (PSUPP), which is an extension header of a GTP-U header according to an embodiment of the present disclosure.

Referring to FIG. 10, in uplink traffic from the RAN to the UPF, a conventional PSUPP protocol as in FIG. 10 may be used as an extension header of GTP-U. New information elements of FIG. 10 may further include at least one of a DL data rate result, a DL congestion result, a DL packet transmission count result, a DL packet retransmission count result, a DL packet retransmission ratio result, a DL packet drop count result, a DL packet drop ratio result, an UL data rate result, an UL congestion result, an UL packet transmission count result, an UL packet retransmission count result, an UL packet retransmission ratio result, an UL packet drop count result, and an UL packet drop ratio result, or thus QoS information measured by the RAN may be transmitted the UPF.

FIG. 11 illustrates an example of a case in which the UPF directly reports collected QoS measurement information to the consumer NF according to an embodiment of the present disclosure.

Referring to FIG. 11, the UPF may use at least one of a performance value received from the RAN or a performance value measured from the UPF as requested in FIGS. 5 and 6, and may transmit the performance value directly to the consumer NF or to the NEF. In this case, in addition to a conventional QOS_MONITORING value, TRAFFIC_MONITORING may be used as one example of eventType, and a performance measurement value may be added to trafficMonitoringMeasurement so that a conventional notificationItems include at least one piece of information of a data rate, a congestion level, a packet transmission count, a packet retransmission count, a packet retransmission ratio, a packet drop count, and a packet drop ratio. In addition, at least one of a session identifier or a QoS flow identifier which is an object of performance measurement may be added.

FIG. 12 illustrates another example of a case in which a UPF directly reports the collected QoS measurement information to the consumer NF according to an embodiment of the present disclosure.

Referring to FIG. 12, FIG. 12 is similar to FIG. 11, but a conventional QOS_MONITORING value may be reused as an eventType, and a performance measurement value may be included in qosMonitoringMeasurement.

FIG. 13 illustrates an example of reporting of the UPF to the SMF according to an embodiment of the present disclosure.

Referring to FIG. 13, PFCP session report of the UPF may transmit the result of selection of one of a value measured from the UPF and a value measured from the RAN or combination thereof to the SMF in the case of FIG. 8, and may transmit only a value measured from the UPF to the SMF in the case of FIG. 9. In this case, a Traffic Monitoring Report may be added so that a conventional PFCP session reporting rule includes at least one of a data rate, a congestion level, a packet transmission count, a packet retransmission count, a packet retransmission ratio, a packet drop count, or a packet drop ratio. In addition, at least one of the session identifier or the QoS flow identifier as an object of performance measurement may be added.

FIG. 14 illustrates another example of reporting of the UPF to the SMF according to an embodiment of the present disclosure.

Referring to FIG. 14, as illustrated in FIG. 13, PFCP session report of the UPF may transmit the result of the selection of one of a value measured from the UPF and a value measured from the RAN or combination thereof to the SMF in the case of FIG. 8, and may transmit only a value measured from the UPF to the SMF in the case of FIG. 9.

In addition, according to one embodiment, although similar to FIG. 13, a conventional QoS Monitoring Report may be reused, and a performance measurement value may be included in the QoS monitoring report.

FIG. 15 illustrates an example of reporting of the RAN to the SMF according to an embodiment of the present disclosure.

Referring to FIG. 15, as requested in FIG. 7, when the RAN includes a performance value measured by the RAN in PDU Session Resource Notify Transfer and transmits the performance value to the AMF so that the performance value is transmitted to PDU SESSION RESOURCE NOTIFY, the AMF may transmit PDU Session Resource Notify Transfer to the SMF by including the same in Nsmf_PDUSession_UpdateSMContext req.

FIG. 16 illustrates an example of reporting of the SMF to the PCF according to an embodiment of the present disclosure.

Referring to FIG. 16, the SMF may transmit a performance measurement value received by the UPF in FIG. 8, or a performance measurement value of the selection of one of a performance measurement value received from the RAN and a performance measurement value received from the UPF or combination thereof in FIG. 9 to the PCF. In this case, a performance measurement value and at least one of the session identifier or the QoS flow identifier which is an object of performance measurement may be added to a conventional SmPolicyUpdateContextData and be transmitted.

FIG. 17 illustrates an example of reporting of the PCF to the consumer NF according to an embodiment of the present disclosure.

In FIGS. 8 and 9, the PCF may transmit a performance value received from the SMF directly or indirectly through the NEF to the consumer NF. In this case, according to one embodiment, the performance value may be added to a conventional EventsNotification and be transmitted. In addition, the PCF may transmit the performance value by further adding received notifCorreld in FIG. 3 to the performance value.

FIG. 18 illustrates an example of measuring at least one of a data rate, a congestion level, a packet transmission count, a packet retransmission count, a packet retransmission ratio, a packet drop count, or a packet drop ratio according to an embodiment of the present disclosure.

Referring to FIG. 18, a PSA UPF is a UPF that serves as an anchor among UPFs and is located between 5G and DN, and may be applied when there is an N9 reference point in FIG. 1. Arrowheads represent packet direction of uplink or downlink and black circles of arrowtails represent where performance measurement is performed for the corresponding uplink or downlink packets. Measurement result of a data rate, a congestion level, a packet transmission count, a packet retransmission count, a packet retransmission ratio, a packet drop count, or a packet drop ratio received from the RAN by the UPF may also considered as a measurement whether or not the UPF processes the received the measurement report from the RAN.

In a case in which there is no N9 reference point, only one PSA UPF may be applied without an intermediate UPF. The RAN, the UPF, and the PSA UPF may measure at least one of a data rate, a congestion level, a packet transmission count, a packet retransmission count, a packet retransmission ratio, a packet drop count, or a packet drop ratio of each of uplink or downlink. According to one embodiment, the uplink data rate of the RAN is a data rate of data sent by the RAN to the UPF, and the downlink data rate of the RAN may be a data rate of data sent from the RAN to the UE. The above-described data rates may be measured and averaged for a predetermined period of time window and expressed as a bit rate per second.

According to an embodiment, each of a packet transmission count, a packet retransmission count, a packet retransmission ratio, a packet drop count, and a packet drop ratio may be measured to be uplink or downlink in the RAN, the UPF, and the PSA UPF.

Instruction of the measurement of at least one of a data rate, a congestion level, a packet transmission count, a packet retransmission count, a packet retransmission ratio, a packet drop count, or a packet drop ratio may be in accordance to FIG. 2, and reporting of measured results may be in accordance to FIG. 8 or 9.

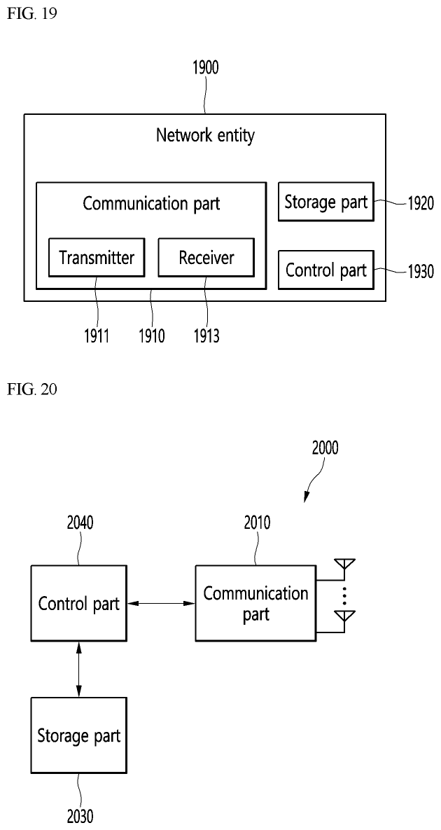

FIG. 19 illustrates configuration of a network entity in a wireless communication system according to various embodiments of the present disclosure. The network entity of the present disclosure is a concept including network function according to system implementation. Terms such as “˜part” and “˜device” used below refer to a unit that processes at least one function or operation, which may be implemented by hardware or software, or a combination of hardware and software. The network entity 1900 according to various embodiments of the present disclosure may include a communication part 1910, a storage part 1920, and a control part 1930 that controls the overall operation of the network entity 1900. The communication part 1910 transmits and receives signals with other network entities. Accordingly, all or part of the communication part 1910 may be referred to as “a transmitter 1911”, “a receiver 1913” or “a transceiver 1910”. The storage part 1920 stores data such as a basic program, an application program, and setting information for the operation of the network entity 1900. The storage part 1920 may consist of volatile memory, non-volatile memory, or a combination of volatile and non-volatile memories. In addition, the storage part 1920 provides stored data according to the request of the control part 1930. The control part 1930 controls overall operations of the network entity 1900. For example, the control part 1930 transmits and receives signals through the communication part 1910. In addition, the control part 1930 writes data in the storage part 1920 and reads the data. In addition, a control part 1930 may perform the functions of protocol stack required by communication standards. To this end, the control part 1930 may include a circuit, an application-specific circuit, at least one processor, or microprocessor, or may be part of a processor. In addition, a part of the communication part 1910 and the control part 1930 may be referred to as a communication processor (CP). The control part 1930 may control the network entity 1900 to perform any one operation among various embodiments of the present disclosure. The communication part 1910 and the control part 1930 do not necessarily have to be implemented as separate modules, but may be implemented as a single component in the form of a single chip or software block. The communication part 1910, the storage part 1920, and the control part 1930 may be electrically connected to each other. In addition, operations of the network entity 1900 may be realized by including the storage part 1920 storing a corresponding program code in the network entity 1900. The network entity 1900 includes a network node, and may be any one of the RAN, the network slice selection function (NSSF), the network exposure function (NEF), the NF repository function (NRF), the policy control function (PCF), the unified data management (UDM), the application function (AF), the authentication server function (AUSF), the access and mobility management function (AMF), and the session management function (SMF).

FIG. 20 illustrates the configuration diagram of the RAN in the wireless communication system according to various embodiments of the present disclosure. The configuration illustrated in FIG. 20 may be understood as the configuration of the RAN 2000. Terms, such as “part,” and “device,” used hereinafter refer to a unit that processes at least one function or operation, which may be implemented in hardware or software, or a combination of hardware and software.

Referring to FIG. 20, the RAN may include a wireless communication part 2010, a backhaul communication part 2020, a storage part 2030, and a control part 2040.

The wireless communication part 2010 may transmit and receive a wireless signal through a wireless channel. For example, the wireless communication part 2010 may perform a conversion function between a baseband signal and a bit stream according to the physical layer standard of a system. In addition, the wireless communication part 2010 may generate complex symbols by encoding and modulating a transmitted bit stream when transmitting data. When receiving data, the wireless communication part 2010 may restore a received bit stream by demodulating and decoding a baseband signal.

The wireless communication part 2010 may up-convert a baseband signal into a radio frequency (RF) band signal, transmit the signal through an antenna, and down-convert an RF band signal received through the antenna into the baseband signal. To this end, the wireless communication part 2010 may include a transmission filter, a receive filter, an amplifier, a mixer, an oscillator, a digital to analog converter (DAC), and an analog to digital converter (ADC), etc.

The wireless communication part 2010 may include multiple transmission and reception paths, and may further include at least one antenna array composed of multiple antenna elements.

In terms of hardware, the wireless communication part 2010 may include a digital unit and an analog unit, wherein the analog unit may include multiple sub-units according to operating power and operating frequency, etc. The digital unit may be implemented with at least one processor (e.g., a digital signal processor (DSP)).

The wireless communication part 2010 may transmit and receive wireless signals as described above. Accordingly, all or part of the wireless communication part 2010 may be referred to as “a transmitter”, “a receiver”, or “a transceiver”. In addition, in the following description, transmission and reception performed through a wireless channel may include processing as described above by the wireless communication part 2010.

The backhaul communication part 2020 may provide an interface for performing communication with other nodes in a network. That is, the backhaul communication part 2020 may convert bit streams transmitted from a RAN to other nodes, such as other access nodes, other RANs, upper nodes, and core networks, etc. into physical signals, and may convert physical signals received from other nodes into bit streams.

The storage part 2030 may store data such as a basic program, an application program, and setting information for operating a RAN. The storage part 2030 may consist of volatile memory, non-volatile memory, or a combination of volatile memory and non-volatile memory. In addition, the storage part 2030 may provide stored data according to the request of the control part 2040.

The control part 2040 may control overall operations of a RAN. For example, the control part 2040 may transmit and receive signals through the wireless communication part 2010 or the backhaul communication part 2020. In addition, the control part 2040 may write data in the storage part 2030 and read the data. In addition, the control part 2040 may perform protocol stack functions required by a communication standard.

To this end, the control part 2040 may include at least one processor.

According to various embodiments of the present disclosure, the control part 2040 may control the performance of operations of the RAN according to the various embodiments described above in FIGS. 1 to 19.

According to various embodiments of the present disclosure, it is possible to request the monitoring of at least one of a downlink data rate, a downlink congestion level, an uplink data rate, an uplink congestion level, a downlink packet transmission count, an uplink packet transmission count, a downlink packet retransmission count, an uplink packet retransmission count, a downlink packet retransmission ratio, an uplink packet retransmission ratio, a downlink packet drop count, an uplink packet drop count, a downlink packet drop ratio, or an uplink packet drop ratio to at least one of the radio access network and the user plane function in a mobile communication network including at least one of the radio access network, the user plane function, the session management function, or the policy control function.

According to one embodiment, the session management function may perform the measurement request to the radio access network or the user plane function.

According to one embodiment, for the measurement request to the radio access network or the user plane function, the session management function may request by further including at least one of a threshold of the downlink data rate, a threshold of the downlink congestion level, a threshold of the uplink data rate, a threshold of the uplink congestion level, a threshold of the downlink packet transmission count, a threshold of the uplink packet transmission count, a threshold of the downlink packet retransmission count, a threshold of the uplink packet retransmission count, a threshold of the downlink packet retransmission ratio, a threshold of the uplink packet retransmission ratio, a threshold of the downlink packet drop count, a threshold of the uplink packet drop count, a threshold of the downlink packet drop ratio, or a threshold of the uplink packet drop ratio.

According to one embodiment, the measurement request to the user plane function may further include at least one of an event notification URI which can be reported directly, a notification correlation identifier, or a duplicate reporting flag.

According to one embodiment, for the QoS monitoring request of user traffic, the policy control function may request monitoring of at least one of the downlink data rate, the downlink congestion level, the uplink data rate, the uplink congestion level, the downlink packet transmission count, the uplink packet transmission count, the downlink packet retransmission count, the uplink packet retransmission count, the downlink packet retransmission ratio, the uplink packet retransmission ratio, the downlink packet drop count, the uplink packet drop count, the downlink packet drop ratio, or the uplink packet drop ratio to the session management function through PCC rules.

According to one embodiment, for measurement request, the policy control function may authorize received measurement request of at least one of the downlink data rate, the downlink congestion level, the uplink data rate, the uplink congestion level, the downlink packet transmission count, the uplink packet transmission count, the downlink packet retransmission count, the uplink packet retransmission count, the downlink packet retransmission ratio, the uplink packet retransmission ratio, the downlink packet drop count, the uplink packet drop count, the downlink packet drop ratio, or the uplink packet drop ratio.

According to one embodiment, a mobile communication network including at least one of the radio access network, the user plane function, the session management function, or the policy control function may report at least one of the downlink data rate, the downlink congestion level, the uplink data rate, the uplink congestion level, the downlink packet transmission count, the uplink packet transmission count, the downlink packet retransmission count, the uplink packet retransmission count, the downlink packet retransmission ratio, the uplink packet retransmission ratio, the downlink packet drop count, the uplink packet drop count, the downlink packet drop ratio, or the uplink packet drop ratio which are measured by the radio access network.

According to one embodiment, the radio access network may report measurement results to the session management function.

According to one embodiment, the radio access network may report measurement results to the session management function by using an NGAP message.

According to one embodiment, the session management function may report measurement results to the policy control function.

According to one embodiment, the radio access network may report measurement results to the user plane function through an extension header of GTP-U.

According to various embodiments of the present disclosure, a mobile communication network including at least one of the radio access network, the user plane function, the session management function, or the policy control function may report at least one of the downlink data rate, the downlink congestion level, the uplink data rate, the uplink congestion level, the downlink packet transmission count, the uplink packet transmission count, the downlink packet retransmission count, the uplink packet retransmission count, the downlink packet retransmission ratio, the uplink packet retransmission ratio, the downlink packet drop count, the uplink packet drop count, the downlink packet drop ratio, or the uplink packet drop ratio, which are measured by the user plane function.

According to one embodiment, the user plane function may report measurements to the session management function.

According to one embodiment, the user plane function may report measurements through one of a PFCP and an SBI.

According to one embodiment, the user plane function may report measurements directly to the consumer NF or NEF.

According to one embodiment, the session management function may report measurement results to the policy control function.

Methods according to embodiments described in the claims or specifications of the present disclosure may be implemented in the form of hardware, software, or a combination of hardware and software.

When implemented in software, a computer readable storage medium storing one or more programs (software modules) may be provided. One or more programs stored in a computer-readable storage medium are configured for execution by one or more processors in an electronic device. One or more programs include instructions for enabling an electronic device to execute methods according to embodiments described in claims or specifications of the present disclosure.

Such programs (software modules, software) may be stored in random access memory, non-volatile memory including flash memory, read only memory (ROM), electrically erasable programmable ROM (EEPROM), a magnetic disc storage device, compact disc-ROM (CD-ROM), digital versatile discs (DVDs), other types of optical storage devices, or magnetic cassettes. Alternatively, such programs may be stored in memory configured as the combination of some or all thereof. In addition, each configuration memory may include multiple configuration memories.

In addition, a program may be stored in an attachable storage device that can be accessed through a communication network such as internet, an intranet, a local area network (LAN), a wide area network (WAN), and a storage area network (SAN), or a communication network configured as a combination thereof. Such a storage device may access a device performing an embodiment of the present disclosure through an external port. In addition, a separate storage device in a communication network may access a device performing an embodiment of the present disclosure.

In the specific embodiments of the present disclosure described above, components included in the disclosure are expressed as singular or plural components according to the specific embodiments presented. However, singular or plural expressions are selected appropriately for the presented situation for convenience of explanation, and the present disclosure is not limited to a singular or plural number of components. Even components expressed in a plural number may include a singular component or even a component expressed in a singular number may include a plural number of components.

Meanwhile, although specific embodiments have been described in the detailed description of the present disclosure, various modifications are possible without departing from the scope of the present disclosure. Therefore, the scope of the present disclosure should not be limited to the described embodiments, but should be determined by not only the scope of the claims to be described later, but also scopes equivalent to the scope of the claims.

In the detailed description and claims of the present disclosure, “A or B” may mean “only A”, “only B”, or “both A and B”. In otherwords, in the detailed description and claims of the present disclosure, “A or B” may be interpreted as “A and/or B”. For example, “A, B, or C” used in the present specification may mean “only A”, “only B”, “only C” or “any combination of A, B, and C”.

A forward slash (/) or comma (,) used in the detailed description and claims of the present disclosure may mean “and/or”. For example, “A/B” may mean “A and/or B”. Accordingly, “A/B” may mean “only A”, “only B”, or “both A and B”. For example, “A, B, C” may mean “A, B or C”.

In the detailed description and claims of the present disclosure, “at least one of A and B” may mean “only A”, “only B”, or “both A and B”. In addition, in the present specification, the expression “at least one of A or B” or “at least one of A and/or B” may be construed in the same manner as “at least one A and B”.

In addition, in the detailed description and claims of the present disclosure, the present specification, “at least one of A, B, and C” may mean “only A”, “only B”, “only C” or “any combination of A, B, and C”. In addition, “at least one of A, B, or C” or “at least one of A, B, and/or C” may mean “at least one of A, B, and C”.

What is claimed is:

1. An operation method of a user plane function (UPF) in a wireless communication system, the method comprising:
receiving a QoS monitoring request from a session management function (SMF),
wherein the QoS monitoring request comprises monitoring of at least one of a data rate, a congestion level, a packet transmission count, a packet retransmission count, a packet retransmission ratio, a packet drop count, or a packet drop ratio.

2. The method of claim 1, wherein the QoS monitoring request further comprises at least one of a threshold of the data rate, a threshold of the congestion level, a threshold of the packet transmission count, a threshold of the packet retransmission count, a threshold of the packet retransmission ratio, a threshold of the packet drop count, or a threshold of the packet drop ratio.

3. The method of claim 1, wherein in the receiving of the QoS monitoring request from the session management function further comprises at least one of a session identifier, a QoS flow identifier, a reporting method, a monitoring period, a reporting frequency, an event notification URI to which report is sent directly, a notification correlation identifier, or a duplicate reporting flag.

4. The method of claim 1, wherein the data rate comprises a data rate for an uplink or a data rate for a downlink,
the congestion level comprises a congestion level for an uplink or a congestion level for a downlink,
the packet transmission count comprises a packet transmission count for an uplink or a packet transmission count for a downlink,
the packet retransmission count comprises a packet retransmission count for an uplink or a packet retransmission count for a downlink,
the packet retransmission ratio comprises a packet retransmission ratio for an uplink or a packet retransmission ratio for a downlink,
the packet drop count comprises a packet drop count for an uplink or a packet drop count for a downlink, or
the packet drop ratio comprises a packet drop ratio for an uplink or a packet drop ratio for a downlink.

5. The method of claim 3, wherein the reporting frequency comprises at least one of periodic reporting, event triggered reporting, or reporting when PDU session is released.

6. An operation method of a radio access network (RAN) in a wireless communication system, the method comprising:
receiving a QoS monitoring request from a session management function (SMF),
wherein the receiving QoS monitoring request comprises requesting monitoring of at least one of a data rate, a congestion level, a packet transmission count, a packet retransmission count, a packet retransmission ratio, a packet drop count, or a packet drop ratio.

7. The method of claim 6, wherein the QoS monitoring request further comprises at least one of a threshold of the data rate, a threshold of the congestion level, a threshold of the packet transmission count, a threshold of the packet retransmission count, a threshold of the packet retransmission ratio, a threshold of the packet drop count, or a threshold of the packet drop ratio.

8. The method of claim 6, wherein the receiving of the QoS monitoring request from the session management function (SMF) comprises requesting at least one of a session identifier to be measured, a QoS flow identifier to be measured, a reporting method, a monitoring period, or a reporting frequency.

9. An operation method of a radio access network (RAN) in a wireless communication system, the method comprising:
performing performance measurement, and
reporting at least one of a data rate, a congestion level, a packet transmission count, a packet retransmission count, a packet retransmission ratio, a packet drop count, or a packet drop ratio which are measured by the RAN to at least one of a session management function (SMF) or a user plane function (UPF).

10. The method of claim 9, wherein the reporting of the results measured by the RAN is performed by using an NGAP message.

11. The method of claim 9, wherein in the reporting of the results measured by the RAN,
the RAN reports the results measured by the RAN to the user plane function (UPF) by using PDU session user plane protocol which is of an extension header of GTP-U.

12. An operation method of a user plane function (UPF) in a wireless communication system, the method comprising:
reporting at least one of a data rate, a congestion level, a packet transmission count, a packet retransmission count, a packet retransmission ratio, a packet drop count, or a packet drop ratio which are information measured by the UPF to a session management function (SMF) or a consumer NF.

13. The method of claim 12, wherein the information measured by the UPF is reported through one of a packet forwarding control protocol (PFCP) and a service based interface (SBI).

14. The method of claim 13, wherein the reporting of the information measured by the UPF through the SBI comprises reporting to a consumer NF using event exposure service of the UPF.

15. The method of claim 12, wherein a data rate measured by the UPF is directly measured by the UPF, or a value measured by a radio access network (RAN) reported to the UPF so that the UPF reports the measured value.

16. The method of claim 12, wherein a congestion level which the UPF measures is measured directly by the UPF, or a value measured by a RAN reported to the UPF so that the UPF reports the measured value.

17. The method of claim 16, wherein the reporting of the value measured by the RAN to the UPF is performed by using PDU session user plane protocol which is an extension header of GTP-U.
